(19) United States
(12) Patent Application Publication
(10) Pub. No.: US 2018/0167314 A1
(43) Pub. Date: Jun. 14, 2018

(54) BACKPRESSURE ROUTING METHOD AND APPARATUS USING DODAG STRUCTURE

(71) Applicants: SEOUL NATIONAL UNIVERSITY R&DB FOUNDATION, Seoul (KR); INDUSTRIAL COOPERATION FOUNDATION CHONBUK NATIONAL UNIVERSITY, Jeonju-si (KR)

(72) Inventors: Seo Hyang KIM, Seoul (KR); Chong Kwon KIM, Seoul (KR); GIHWAN CHO, Jeonju-si (KR); Min-Joon KIM, Suwon-si (KR)

(21) Appl. No.: 15/488,546

(22) Filed: Apr. 17, 2017

(30) Foreign Application Priority Data
Dec. 8, 2016 (KR) 10-2016-0167000

(51) Int. Cl. H04L 12/721; H04L 12/775

(52) U.S. Cl. CPC H04L 45/44; H04L 45/58; H04L 45/14

(57) ABSTRACT

Disclosed herein are a destination oriented directed acyclic graph (DODAG) structure-based backpressure routing apparatus and method for multi-hop communication in a network including a plurality of nodes. The DODAG structure-based backpressure routing apparatus includes: means for selecting at least one of adjacent nodes of each node as a head node group based on a rank value allocated to the each node; and M means for, when a message reaches a certain node, selecting one node, directed to a direction of a destination node, from the head node group, and transferring the message to the selected node.

### BACKGROUND

### 1. Technical Field

The present invention relates generally to destination oriented directed acyclic graph (DODAG)-based backpressure routing in which a DODAG structure used for a low power and lossy network routing technique is applied to a backpressure routing technique, and more particularly to DODAG-based backpressure routing technology for multi-hop communication.

The present invention has been derived from research conducted for Project for Research into Resilient/Fault-Tolerant Autonomous Networking Technology based on the Physical Attributes, Relationships and Roles of IoT Devices sponsored by the Korean Ministry of Science, ITC and Future Planning and the Institute for Information & Communications Technology Promotion [Project Management Number: No. B0190-16-2017] and Project for the Promotion of University ICT Research Centers sponsored by the Korean Ministry of Science, ITC and Future Planning and the Institute for Information & Communications Technology Promotion [Project Management Number: IITP-2017-R0992-17-1023] in 2016.

### 2. Description of the Related Art

In a multi-hop wireless sensor network, each wireless node transfers a message to a final destination via multi-hop communication. A delay tolerant network (DTN) has a disadvantage in that message delay is relatively long because communication is performed by using a method of transferring a message to adjacent nodes, but has advantages in that a network can be easily constructed and high costs are not incurred because the construction of a separate infrastructure is not required.

The communication technique of repeating transfer to an adjacent node a plurality of times when transferring each packet to a final destination node has a network topology based on a concept completely different from that of a general mobile network topology for wireless local area network (LAN) communication, cellular network communication, etc. The most prominent feature that causes the fundamental difference resides in the fact that there is no concept of an access point adapted to connect communication between various wireless nodes. In the delay tolerant network, each node transfers its message to another node by momentarily performing communication only when the node can communicate with the other node. Accordingly, when a certain node transmits a message, the message may not reach a counterpart in the worst case. In practice, according to the DTN-related papers published in famous network-related journals or societies, transmission rate ranges from about 10% to about 60% depending on data lifetime or other parameters, which is significantly low. It will be apparent that, when data lifetime is set to a considerably long period, the size of a queue is set to a considerably large size, and encountered nodes are made to have duplicates, a larger number of nodes will receive a message without packet drop over time, with the result that data will be transferred to a final destination node.

However, message transmission based on the above transfer method has a disadvantage in that in the worst case, data may not reach a counterpart. In order to maximize network transmission throughput in multi-hop communication, backpressure routing techniques (see [1]) have been constantly researched, but these techniques have serious delay and loop problems (see [2], [3], and [4]).

A typical backpressure routing algorithm is a routing technique that transfers a message to a final destination node based on the total numbers of packets contained in the queues of respective nodes upon packet transmission within a network. The typical backpressure routing algorithm ensures that total network transmission throughput is maximized in a delay tolerant network. Unlike a general routing technique, this algorithm manages a per-destination queue, allows the sum of the squares of the numbers of packets in queues present in an overall network to be minimized upon determination of routing, and determines a packet candidate to be transferred based on the differences between the numbers of packets contained in the queues (see [6]). By considering the wireless channel states of a plurality of links present between the determined transmission packet candidate of each node and each adjacent node, network topology, etc., a link capable of maximizing network transmission throughput without interference at one time is activated, and the corresponding packet candidate is substantially transmitted via the selected link.

In the backpressure routing, when a packet of one node is transferred to another node, the transfer is performed based on the numbers of packets contained in per-destination queues. In the case of a wireless channel, two pieces of information are simultaneously transmitted over a shared channel, packets collide with each other, and thus only one packet can be transmitted at one time. Accordingly, since only one packet can be also transmitted via a wireless link between certain node 1 and certain node 2 at one time, it is necessary to determine one of a plurality of packets which can maximize overall network efficiency when it is transferred. In this case, the determination is made based on the differences between the numbers of packets contained in queues that belong to different nodes and have the same destination.

Each node may have a plurality of adjacent nodes. For example, when node 1 has k adjacent nodes, one link is present between node 1 and each of its adjacent nodes, and thus node 1 has a total of k links. Meanwhile, only one piece of information can be transmitted over one shared wireless channel at one time. Accordingly, when an adjacent node performs communication, an interference problem may occur. A link to be activated is determined by considering channel situations, network topology, etc., the way to maximize overall transmission throughput via a given channel environment is determined, and also a packet to be transmitted via the activated link is determined.

The backpressure routing algorithm has the strong advantage of maximizing the transmission throughput of an overall network as described above. However, the backpressure routing algorithm has the disadvantage of requiring a large amount of information in advance to perform routing scheduling. Furthermore, there is no predetermined path, and a message is simply transferred based on the numbers of packets contained in the queues of adjacent nodes, and thus a certain level of backpressure is not present when sufficient flow is not present in a network. In this case, a disadvantage may arise in that a packet is not rapidly transmitted to a final destination and strays through the network, thereby causing a serious delay problem. Furthermore, in the backpressure routing algorithm, both routing and scheduling are simultaneously performed at a single step, and thus a disadvantage arises in that the backpressure routing algorithm cannot be applied directly to a network model in which a link layer and a routing layer are separate from each other and are separately processed.

### PRIOR ART DOCUMENTS

### Non-Patent Documents

[1] L. Tassiulas and A. Ephremides, “Stability properties of constrained queueing systems and scheduling policies for maximum throughput in multihop radio networks,” IEEE Transactions on Automatic Control, Vol. 37, pp. 1936-1948, December 1992
[2] A. Warrier, S. Janakiraman, and S. Ha, “DiffQ: Practical differential backlog congestion control for wireless networks,” INFOCOM 2009
[3] S. Moeller, A. Sridharan, and B. Krishnamachari, “Routing without routes: the backpressure collection protocol,” ISPN 2010
[4] Hulya Seferoglu and Eytan Modiano, Separation of Routing and Scheduling in Backpressure-Based Wireless Networks, IEEE/ACM Transactions on Networking, 12 Jun. 2015, ISSN: 1063-6692
[5] Internet Engineering Task Force (IETF), RFC 6550, RPL: IPv6 Routing Protocol for Low-Power and Lossy Networks, ISSN: 2070-1721
[6] https://en.wikipedia.org/wiki/Backpressure routing
[7] Malisa Vucinic, “Routing in IPv6 Sensor Networks,” hal-00831962, 9 Jun. 2013
[8] The University of Southern California's Autonomous Networks Research Group, http://anrg.usc.edu

### SUMMARY

The present invention proposes a new type of reliable, efficient backpressure routing method and apparatus, which are capable of mitigating the loop and transmission delay problems of the conventional backpressure routing algorithm while maintaining the maximization of transmission throughput within a network, which is the greatest advantage of the conventional backpressure routing algorithm.

In order to achieve the above object, the present invention imparts directionality to the message transmission of the conventional backpressure routing technique by applying a destination oriented directed acyclic graph (DODAG) structure, used for a low power and lossy network routing technique, to a backpressure routing technique. The DODAG structure is a structure that is used in the routing protocol for low power and lossy network (RPL), which is a distance vector routing protocol in which each node of a network is connected without a loop. RPL is a distance vector routing protocol, in which each node of a network is connected without a loop. For this purpose, the DODAG structure is employed.

Nodes included in the DODAG structure have a single root node. This root node is referred to as a DODAG root. A DODAG graph is constructed based on an objective function based on a routing metric. For example, in a DODAG graph constructed depending on the distance, a node closer to a root node is located at an upper position in the graph and a node farther from the root node is located at a lower position in the graph, and thus an adjacent node of each node closer to the root node than each node is selected as a head node of each node. When the DODAG structure is employed in multi-hop communication as described above, directionality toward a destination node is imparted to packet transfer. It is sufficient if each node transfers a packet to its head node, and thus a structure capable of solving the loop occurrence problem of conventional multi-hop communication, such as communication using backpressure routing, is provided.

DODAG-based backpressure routing according to an embodiment has been derived from the idea that in multi-hop communication using an RPL DODAG, when each node transfers a packet, efficient communication having directionality can be performed by transferring a packet to a head node. According to an embodiment of the present invention, directionality is imparted to a packet transfer path by selecting a head node of each packet based on a final destination node in order to prevent a situation in which each packet strays through a network because the conventional technology performs packet transfer based on only the difference in the number of packets contained in a queue with regard to adjacent nodes based on regardless of directionality.

According to an embodiment, all nodes within a network do not transfer a message only to a single sink node, but a communication technique appropriate for a situation in which two certain nodes within the network communicate is used. Accordingly, the head node group varies depending on the final destination node. The head node group includes adjacent nodes in a direction that approaches the final destination node. In other words, when the distance between a certain node and the final destination node is shorter than the distance between the specific node and the final destination node, the certain node is a high-level node of the specific node. In the opposite case, the specific node itself is a high-level node of the certain node. In other words, the DODAG graph is constructed by using a method of setting the final destination node as a root and selecting a head node based on the distance to the final destination node. Since any node within the network may be a final destination node, a number of DODAG graphs equal to the number of nodes are generated.

In this manner, a method of selecting a node, which is a node adjacent to a specific node and which is a high-level node of the specific node for a final destination, as a head node of the specific node and transferring a packet having the corresponding final destination to one node of a corresponding head node group is employed. As a result, although a message may be transferred in a direction opposite to the direction of a final destination node in backpressure routing, a packet present within a network is transferred only in a direction approaching the final destination node by using the technique according to the embodiment.

According to a specific feature of an embodiment, a DODAG structure-based backpressure routing method for multi-hop communication in a network including a plurality of nodes is provided. This method includes: selecting at least one of the adjacent nodes of each node as a head node group based on a rank value allocated to the each node; and, when a message reaches a certain node, selecting one node, directed to the direction of a destination node, from the head node group, and transferring the message to the selected node.

According to another feature of an embodiment, there is provided a DODAG structure-based backpressure routing method for multi-hop communication in a network including a plurality of nodes, the method including: defining a destination node as a root node, setting the rank value of the root node to 0, and allocating the rank value of the each node based on a link state between nodes; selecting at least one of the adjacent nodes of each node as a head node group based on the rank value allocated to the each node; and, when a message reaches a certain node, selecting one node, directed to the direction of the destination node, from the head node group, and transferring the message to the selected node, thereby imparting directionality to a message transfer path.

Allocating the rank value of the each node based on the link state between the nodes may include calculating the rank value of each node by using a DODAG structure-based rank value calculation method in RPL.

Selecting at least one of the adjacent nodes of each node as the head node group based on the rank value allocated to each node may include comparing rank values having the final destination node as a root with the rank values of the adjacent nodes of the certain node, and selecting nodes of the adjacent nodes having rank values smaller than the rank value of the certain node as the head node group.

Selecting the one node, directed to the direction of the destination node, from the head node group, and transferring the message to the selected node may include selecting, by the certain node, one node from its own head node group based on packet queue differences, and selecting, by the certain node, a node having the greatest queue difference.

According to still another feature of an embodiment, there is provided a DODAG structure-based backpressure routing apparatus for multi-hop communication in a network including a plurality of nodes, the apparatus including: means for selecting at least one of adjacent nodes of each node as a head node group based on a rank value allocated to each node; and means for, when a message reaches a certain node, selecting one node, directed to a direction of a destination node, from the head node group, and transferring the message to the selected node.

According to still another feature of an embodiment, there is provided a DODAG structure-based backpressure routing apparatus for multi-hop communication in a network including a plurality of nodes, the apparatus including: means for defining a destination node as a root node, setting the rank value of the root node to 0, and allocating the rank value of each node based on a link state between nodes; means for selecting at least one of the adjacent nodes of the each node as a head node group based on the rank value allocated to the each node; and means for, when a message reaches a certain node, selecting one node, directed to the direction of the destination node, from the head node group, and transferring the message to the selected node.

The means for allocating the rank value of each node based on the link state between the nodes may include means for calculating the rank value of the each node by using a DODAG structure-based rank value calculation method in RPL.

The means for selecting at least one of the adjacent nodes of the each node as the head node group based on the rank value allocated to the each node may include means for comparing rank values having the final destination node as a root with the rank values of the adjacent nodes of the certain node, and selecting nodes of the adjacent nodes having rank values smaller than the rank value of the certain node as the head node group.

The means for selecting the one node, directed to the direction of the destination node, from the head node group and transferring the message to the selected node may include means for selecting, by the certain node having received the message, one node from its own head node group based on packet queue differences and selecting, by the certain node having received the message, a node having the greatest queue difference.

Via the features of the above-described method or apparatus, the advantage “maximization of transmission throughout within a network,” i.e., the most powerful feature of the backpressure routing algorithm, can be preserved, and also a packet can be transferred only in a direction approaching a final destination node, thereby enabling the packet to be transferred to the final destination within a shorter period of time.

As described above, an embodiment of the present invention does not consider transfer to a node, other than a head node, but considers only transfer to the head node when comparing the number of packets contained in a queue with those of adjacent nodes, and thus “the maximization of transmission throughput within a network,” i.e., the powerful advantage of the backpressure routing algorithm, can be maintained without change. Link activation vector candidate calculation or objective function calculation shares equations with the backpressure routing algorithm, thereby ultimately leading to the result of compensating for the disadvantage of the conventional algorithm while maintaining the advantage related to the maximization of transmission throughput within a network.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating the principle of a routing method for transferring a message from node A to node B, i.e., a final destination, according to an embodiment.

FIG. 2 is a flowchart showing the process of a backpressure routing method according to an embodiment;

FIG. 3 is a graph illustrating a method of selecting a head node based on a DODAG structure according to an embodiment;

FIG. 4 is a graph illustrating a specific example of a routing method according to an embodiment;

FIG. 5 is a graph showing the comparisons between the average delay time of the conventional backpressure routing technique and the average delay time of the proposed technique according to an embodiment; and

FIG. 6 graph showing the comparisons between the average delay time of the conventional backpressure routing technique and the average delay time of the proposed technique for various flow values according to an embodiment.

### DETAILED DESCRIPTION

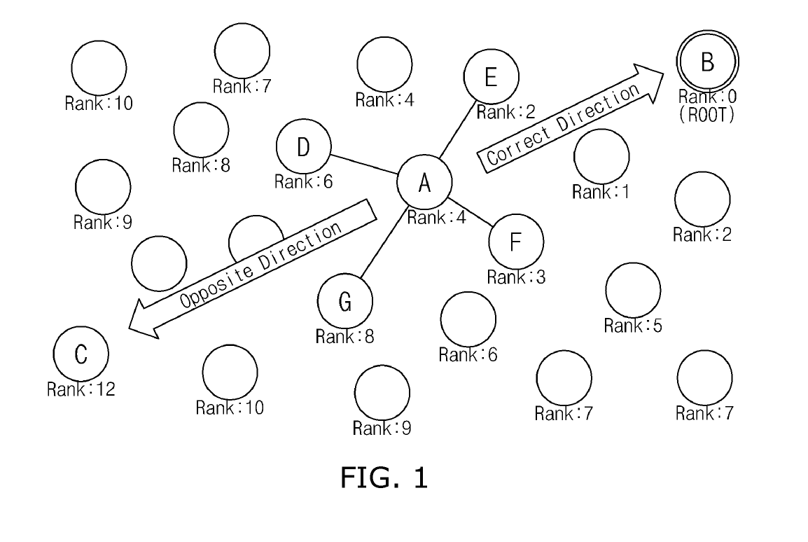

FIG. 1 is a diagram showing a routing method for transferring a message from node A to node B, i.e., a final destination, according to an embodiment.

A message is transferred from one node to another node within a network and then reaches a final destination B via a backpressure routing technique. In the case of the conventional backpressure routing technique, a link is selected by using only queue differences without considering directionality. Accordingly, the message may be directed to node C in the direction opposite to the direction of the final destination of the message, which may result in serious message transmission delay. In the worst case, this may lead to a result in which the message continues to stray through the network.

According to an embodiment, a DODAG structure having node B as a root node is constructed as described below. The rank value of root node B is set to 0. Furthermore, a rank value of each node is allocated based on a link state between nodes. Generally, a rank value allocated to certain node K refers to the overhead it takes to transfer a message from the corresponding node K to a head node. Accordingly, a rank value to be allocated is proportional to the distance from node B. According to an embodiment, based on these rank values, a specific node selects nodes having values smaller than the rank values of its own adjacent nodes as a head node group, selects one node, directed to the direction of the destination node, from the head node group, and then transfers the message to the selected node.

In other words, in the exemplary graph of FIG. 1, node A has links directed to directions D, E, F, and G. In the case of a typical backpressure technique, these four links are all activated, and thus the message may be transferred in any one of the directions. If the message is transferred to node D or node G, a link directed to the direction opposite to the direction of node B has been selected. Accordingly, it may take a long period of time for the message to be transferred to node B, i.e., a final destination node, or a phenomenon in which the message may stray through the network may occur.

However, according to an embodiment, node A selects node E (rank=2) and node F (rank=3) having rank values smaller than its own rank=4 as its own head node group, and then transfers the message only to node E or node F in a direction approaching final destination node B (a correct direction) upon the transfer of the message. This enables the disadvantage of the conventional backpressure routing to be overcome.

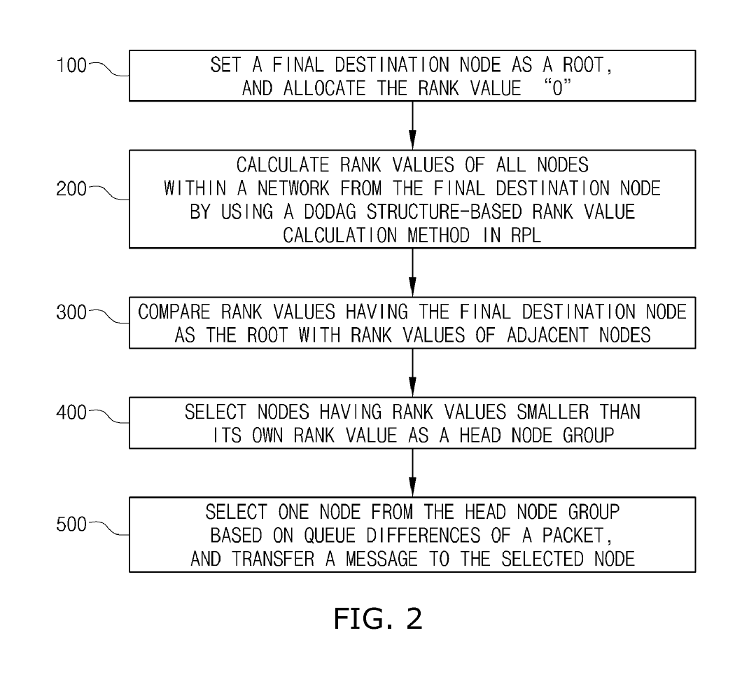

FIG. 2 is a flowchart showing the process of a backpressure routing method according to an embodiment.

First, a backpressure routing apparatus sets a final destination node as a root, and allocates rank value “0” to the root at step 100. Meanwhile, the backpressure routing apparatus according to the embodiment may be implemented as an independent apparatus, or may be implemented via at least one of all nodes within a network. Alternatively, the backpressure routing apparatus according to an embodiment may be implemented using at least part of network components, such as a switch, a gateway, a network controller, a high-level server, etc., which control the multi-hop communication of all nodes within the network or which are directly or indirectly (for example, via another node) connectable to all the nodes within the network.

The backpressure routing apparatus calculates the rank values of all the nodes within the network from the final destination node by using a DODAG structure-based rank value calculation method in RPL at step 200. When the number of nodes within the network is N, the rank values of all the nodes within the network from node K are calculated for N nodes by using node K as a root. In the above calculation, a method of obtaining rank values in RPL based on a DODAG structure may be used.

A further description is now given in connection with initial rank value calculation overhead. In a typical sensor network in which backpressure routing is used, all nodes do not become the destination nodes of a message, but, rather, a single specific node becomes a root or sync node and functions as a gateway that collects sensing information occurring in the network and transmits the collected information to a high-level server. Accordingly, in practice, it is sufficient if the rank value of each node is calculated by using only the sink node of the N nodes, which will actually receive a message, as a root.

Thereafter, the backpressure routing apparatus compares rank values, having the final destination node as the root, with the rank values of adjacent nodes at step 300, and selects nodes having rank values smaller than the rank value of each node from among the adjacent nodes as a head node group at step 400. The selection of the head node group is performed by comparing rank values having final destination node K as the root with those of adjacent nodes for the N nodes within the network and then selecting nodes having rank values smaller than the rank value of each node as the head node group. In this case, the selected head node group is a node group that is closer to the final destination K than each node.

When receiving a message, the backpressure routing apparatus selects one node from the head node group based on packet queue differences and transfers the message to the selected node at step 500.

According to the present invention, all nodes within a network do not transfer a message only to a single sink node, but a communication technique appropriate for a situation in which two certain nodes within the network communicate is used. Accordingly, the head node group varies depending on the final destination node.

The head node group includes adjacent nodes in a direction that approaches the final destination node. In other words, when the distance between a certain node and the final destination node is shorter than the distance between the specific node and the final destination node, the certain node is a high-level node of the specific node. In the opposite case, the specific node itself is a high-level node of the certain node. In other words, the DODAG graph is constructed by using a method of setting the final destination node as a root and a head node based on the distance to the final destination node.

Since any node within the network may be the final destination node, a number of DODAG graphs equal to the number of nodes are generated. In this manner, a method of selecting a node, which is a node adjacent to a specific node and which is a high-level node of the specific node for a final destination, as a head node of the specific node and transferring a packet having the corresponding final destination to one node of a corresponding head node group is employed.

As a result, although a message may be transferred in a direction opposite to the direction of a final destination node in backpressure routing, a packet present within a network is transferred only in a direction approaching the final destination node by using the technique according to an embodiment.

As described above, the present invention does not consider transfer to a node, other than a head node, but considers only transfer to the head node when comparing the number of packets contained in a queue with those of adjacent nodes, and thus “the maximization of transmission throughput within a network,” i.e., the powerful advantage of the backpressure routing algorithm, can be maintained without change. Link activation vector candidate calculation or objective function calculation shares equations with the backpressure routing algorithm, thereby ultimately leading to the result of compensating for the disadvantage of the conventional algorithm while maintaining the advantage related to the maximization of transmission throughput within a network.

Meanwhile, the backpressure routing apparatus according to an embodiment may include: a means for selecting at least one of the adjacent nodes of each node as a head node group based on a rank value allocated to each node; and a means for, when a message reaches a certain node, selecting one node, directed to the direction of the destination node, from the head node group and transferring the message to the selected node. Furthermore, backpressure routing apparatus further includes a means for defining a destination node as a root node, setting the rank value of the root node to 0, and allocating the rank value of each node based on a link state between nodes.

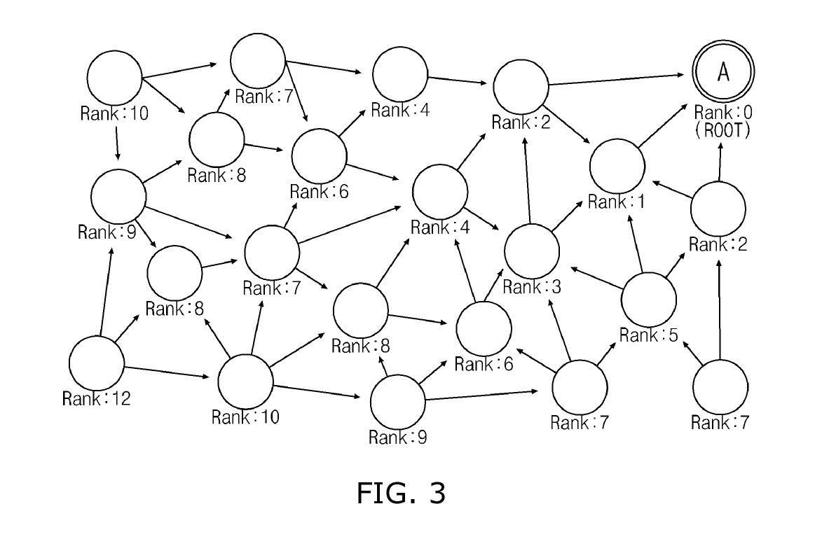

FIG. 3 is a graph illustrating a method of selecting a head node based on a DODAG structure according to an embodiment.

When the backpressure routing apparatus calculates rank values having node A as a root, the rank values shown in FIG. 3 are obtained. Each node selects nodes having rank values smaller than its own rank value from among adjacent node as a head node group.

In FIG. 3, when the arrow between nodes is located at certain node X in direction Y, this indicates that node Y is one of the head nodes of node X. When certain node X receives a message, certain node X selects one of its own head nodes, and transfers the message to the selected node. In this case, a criterion for the selection is based on queue differences, as in backpressure routing.

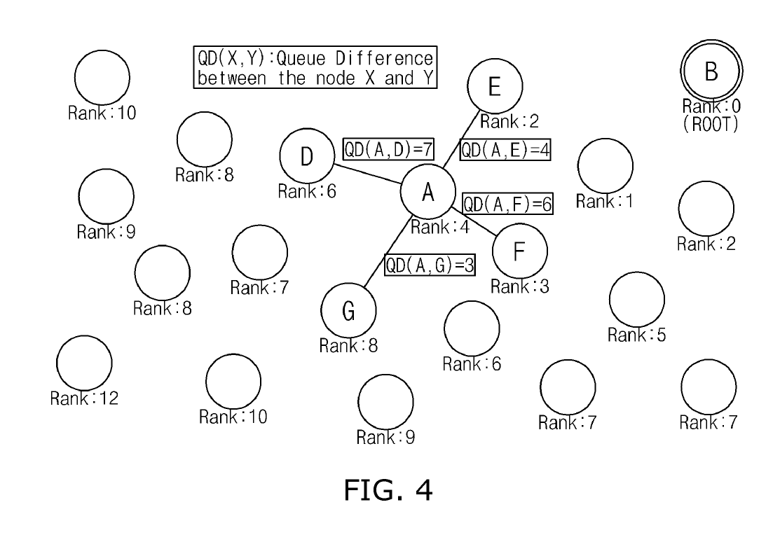

A specific example of routing is now described with reference to FIG. 4.

FIG. 4 is a graph illustrating a specific example of a routing method according to an embodiment. FIG. 4 shows a case where node A attempts to transfer a message to final destination node B. In this case, the adjacent nodes of node A are four nodes D, E, F and G. In the backpressure routing, the backpressure routing apparatus selects a link having the greatest difference by considering queue differences (QDs) with respect to respective nodes. In this case, the queue differences of links A-D, A-E, A-F, and A-G, i.e., QD(A,D), QD(A,E), QD(A,F), and QD(A,G), are 7, 4, 6, and 3, respectively. Link A-D having the largest value is selected from among the links, and then node A transfers a message to node D.

In contrast, the present invention considers both the directionality of a message and QDs, rather than simply considering only QDs. In other words, since the rank value of node A is 4 and the ones of the adjacent nodes, having values smaller than its own rank value, are nodes E and F, node A selects nodes E and F as its own head node group (see step 400 of FIG. 2). As described above, the present invention considers only nodes belonging to the head node group upon transfer of a message, and thus the message is transferred to one of nodes E and F, i.e., the nodes directed to final destination node B. Link A-F having the greatest QD is selected from between links A-E and A-F, and accordingly node A transfers the message to node F.

Referring to the example of FIG. 4, the conventional backpressure routing and the backpressure routing according to an embodiment are compared with each other. In the case of the conventional backpressure routing, node A transfers a message to one node of its own adjacent node group {D,E,F,G} having the greatest queue difference, thereby resulting in the selection of node D. The conventional backpressure routing considers only queue differences upon transfer of a message. In the worst case, the message may stray through a network, and thus may not reach the final destination node.

In contrast, in the backpressure routing according to an embodiment, node A selects a head node group {E,F} from its own adjacent node group {D,E,F,G} based on rank values, and transfers a message to the node of its own head node group {D,E,F,G} having the greatest queue difference. In other words, node A selects node F, and transfers a message to node F. As a result, directionality is imparted to message transfer, thereby mitigating a message transmission delay problem and preventing the occurrence of a loop.

Via this configuration, the advantage “maximization of transmission throughout within a network,” i.e., the most powerful feature of the backpressure routing algorithm, can be preserved, and also a packet can be transferred only in a direction approaching a final destination node, thereby enabling the packet to be transferred to the final destination within a shorter period of time.

Simulations for the evaluation of performance were carried out using C++-based backpressure routing code. In a test file, the implementation of the backpressure algorithm and whether to use a DODAG structure were allowed to be selected. Operation could be performed using only basic C++ libraries without requiring particular libraries. The packet transmission between network nodes was implemented using a push-pop concept. Basically, the number of transmitted packets and the total number of transmissions were calculated based on the amount of traffic within a network. The communication between nodes within the network was implemented via cells. 44 nodes were randomly distributed within a cell grid having a size of 6×6, and the number of nodes was 44, which was 1.2 times the number of cells. The queue size of each node was set to 500. Nodes were randomly distributed in the cell grid having the predetermined size, and then packet transmission were performed for the span of simulation time. During simulation time, packets were generated at traffic flow probability. Table 1 shows the principal parameter values of a simulation environment:

TABLE 1

| | |
|---|---|
| The number of cells | 36 |
| The number of nodes | 44 |
| Simulation time | 10,000 |
| Packet generation | 0.1 |
| probability | |

The performance of the conventional backpressure algorithm and the performance of the algorithm using a DODAG according to an embodiment were compared with each other via tests. The amount of traffic was controlled by changing packet generation probability in a basic test environment. Table 2 shows the averages of results that were obtained through ten simulations:

TABLE 2

| | | DODAG- |
|---|---|---|
| | Back- | based |
| | pressure- | algorithm |
| | based | (present |
| | algorithm | invention) |
| Generated packets | 44,088 | 44,285 |
| Received packets | 42,749 | 43,805 |
| Total transmissions | 189,617 | 155,888 |
| Reliability | 96.96% | 98.92% |

It can be seen that on average, 44,088 packets were generated in the backpressure-based algorithm and 44,285 packets were generated in the DODAG-based algorithm, and thus there was no great difference between the two algorithms. However, it can be seen that in the case of the number of received packets, the DODAG-based algorithm is slightly superior to the backpressure-based algorithm. It can be seen that only 480 packets corresponding to about 1% of about 44,000 packets were lost. In contrast, more than 1000 packets were lost in the general backpressure algorithm.

It can be seen that in the case of total transmissions, the backpressure-based algorithm make about 30,000 more transmission attempts than the DODAG-based backpressure algorithm. In these tests, when a packet had not been transferred to a destination within a predetermined timeslot, this was considered to be a transmission error (in this environment, transmission was performed without disconnection). In this case, it should be noted that the DODAG-based algorithm successfully transmitted a larger number of packets through a smaller number of transmissions.

As a result, the DODAG-based algorithm successfully transmitted a larger number of packets within the same time period. This can be easily understood from the average delay times of respective nodes in the general backpressure algorithm and the DODAG-based algorithm.

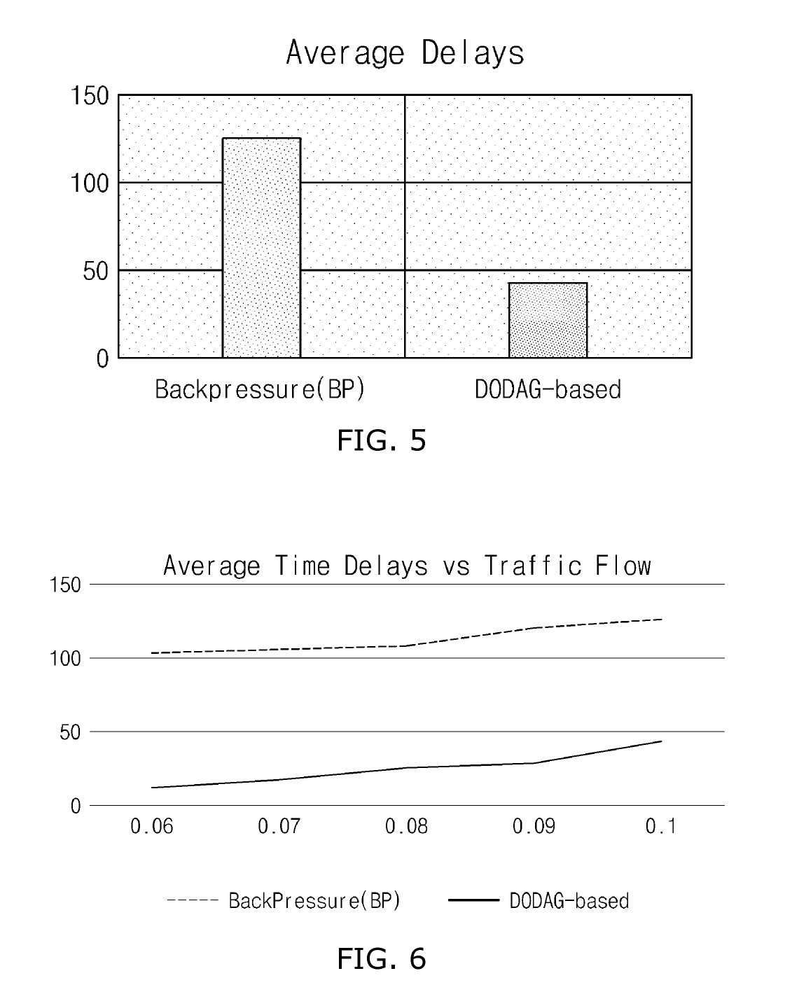

FIG. 5 is a graph showing the comparisons between the average delay time of the conventional backpressure routing technique and the average delay time of the proposed technique according to an embodiment. In FIG. 5, the average time delay of the conventional backpressure technique at nodes was compared. The average delay time was 126 in the conventional backpressure technique, and the average delay time of nodes was 43 in the proposed technique according to an embodiment. In the DODAG-based environment, the average delay time was reduced by about 65% compared to that of the conventional backpressure technique. Although the same number of packets were transmitted within a test timeslot by using the two techniques, the DODAG-based environment exhibited a higher transmission success rate.

FIG. 6 graph showing the comparisons between the average delay time of the conventional backpressure routing technique and the average delay time of the proposed technique for various flow values according to an embodiment. FIG. 6 is a graph showing the comparisons between performances in various network environments by increasing traffic flow probability in order to conduct more accurate tests. The measure of the performance was the average delay time of each node in the same manner. The graph of FIG. 6 was obtained by changing traffic flow probability from 0.06 to 0.10. Although per-node delay time was increased in accordance with traffic flow probability, the per-node delay time was not considerably increased. The DODAG-based environment exhibited more efficient queue delay time than the conventional backpressure environment.

As described above, the proposed technique according to the embodiment reduced the number of transmissions over a network by imparting directionality to message transmission by using a DODAG-based structure, thereby improving the efficiency of the queue management of each node. As a result, the proposed technique successfully transmitted a larger number of messages to a final destination node through a smaller number of transmissions, thereby achieving higher transmission efficiency and higher transmission reliability.

The backpressure routing is a routing technique intended to maximize transmission throughput within a network. However, since both routing and scheduling are simultaneously performed in the backpressure routing, it is not easy to apply the backpressure routing to actual networks. The proposed routing performance improvement algorithm using a DODAG structure focuses on the improvement of the performance of the DODAG-based backpressure routing algorithm over the performance of the conventional backpressure routing algorithm, and can solve the loop and serious transmission delay problems of the conventional algorithm by using the DODAG structure while maintaining “the maximization of transmission throughput within a network,” i.e., the greatest advantage of the conventional backpressure routing algorithm. According to the results of tests, transmission delay time was decreased by about 65% compared to that of the conventional technique, and transmission rate was improved from 97% to 99% M as a result of the prevention of the occurrence of a loop and the improvement of transmission efficiency.

Although the specific embodiments of the present invention have been disclosed for illustrative purposes, those skilled in the art will appreciate that various modifications, additions and substitutions are possible without departing from the scope and spirit of the invention as disclosed in the accompanying claims.

What is claimed is:

1. A destination oriented directed acyclic graph (DODAG) structure-based backpressure routing method for multi-hop communication in a network including a plurality of nodes, the method comprising:
selecting at least one of adjacent nodes of each node as a head node group based on a rank value allocated to the each node; and
when a message reaches a certain node, selecting one node, directed to a direction of a destination node, from the head node group, and transferring the message to the selected node.

2. The DODAG structure-based backpressure routing method of claim 1, further comprising, before selecting at least one of the adjacent nodes of each node as the head node group based on the rank value allocated to the each node, defining the destination node as a root node, setting a rank value of the root node to 0, and allocating a rank value to the each node based on a link state between nodes.

3. The DODAG structure-based backpressure routing method of claim 2, wherein allocating the rank value of the each node based on the link state between the nodes comprises calculating the rank value of the each node by using a DODAG structure-based rank value calculation method in a routing protocol for low power and lossy network (RPL).

4. The DODAG structure-based backpressure routing method of claim 1, wherein selecting at least one of the adjacent nodes of each node as the head node group based on the rank value allocated to the each node comprises comparing rank values having the final destination node as a root with rank values of adjacent nodes of the certain node, and selecting at least one of the adjacent nodes having rank values smaller than a rank value of the certain node as the head node group.

5. The DODAG structure-based backpressure routing method of claim 1, wherein selecting the one node, directed to the direction of the destination node, from the head node group, and transferring the message to the selected node comprises selecting, by the certain node, one node from its own head node group based on packet queue differences and selecting, by the certain node, a node having a greatest queue difference.

6. A destination oriented directed acyclic graph (DODAG) structure-based backpressure routing apparatus for multi-hop communication in a network including a plurality of nodes, the apparatus comprising:
means for selecting at least one of adjacent nodes of each node as a head node group based on a rank value allocated to the each node; and
means for, when a message reaches a certain node, selecting one node, directed to a direction of a destination node, from the head node group, and transferring the message to the selected node.

7. A destination oriented directed acyclic graph (DODAG) structure-based backpressure routing apparatus for multi-hop communication in a network including a plurality of nodes, the apparatus comprising:
means for defining a destination node as a root node, setting a rank value of the root node to 0, and allocating a rank value of each node based on a link state between nodes;
means for selecting at least one of adjacent nodes of the each node as a head node group based on the rank value allocated to the each node; and
means for, when a message reaches a certain node, selecting one node, directed to a direction of the destination node, from the head node group, and transferring the message to the selected node.

8. The DODAG structure-based backpressure routing apparatus of claim 7, wherein the means for allocating the rank value of the each node based on the link state between the nodes comprises means for calculating the rank value of the each node by using a DODAG structure-based rank value calculation method in routing protocol for low power and lossy network (RPL).

9. The DODAG structure-based backpressure routing apparatus of claim 7, wherein the means for selecting at least one of the adjacent nodes of the each node as the head node group based on the rank value allocated to the each node comprises means for comparing rank values having the final destination node as a root with rank values of adjacent nodes of the certain node, and selecting nodes of the adjacent nodes having rank values smaller than a rank value of the certain node as the head node group.

10. The DODAG structure-based backpressure routing apparatus of claim 7, wherein the means for selecting the one node, directed to the direction of the destination node, from the head node group and transferring the message to the selected node comprises means for selecting, by the certain node having received the message, one node from its own head node group based on packet queue differences and selecting, by the certain node having received the message, a node having a greatest queue difference.
